(19) United States
(12) Patent Application Publication
(10) Pub. No.: US 2010/0142521 A1
(43) Pub. Date: Jun. 10, 2010

(54) Just-in-time near live DJ for internet radio

(75) Inventors: Greg Evans, Raleigh, NC (US); Alfredo Issa, Apex, NC (US); Kunal Kandekar, Morrisville, NC (US)

Correspondence Address: AKERMAN SENTERFITT, 8100 BOONE BOULEVARD, SUITE 700, VIENNA, VA, 22182-2683, US

(73) Assignee: Concert Technology, Durham, NC (US)

(21) Appl. No.: 12/314,289

(22) Filed: Dec. 8, 2008

(51) Int. Cl. H04L 12/56

(52) U.S. Cl. 370/389

(57) ABSTRACT

A system and method for providing near live disc jockey (DJ) audio commentary segments or snippets to a client device including one of an internet radio station host streaming device or a user mobile device for real-time insertion into a music playlist. The system is operative to transmit metadata segment packets to the client device; transmit audio content segment packets to the client device, with the audio content segment packets matching directly to the metadata segment packets. The system also receives usage segment packets as a response from the client device.

### FIELD OF THE INVENTION

The present invention generally relates to a method of and a system for providing near live disc jockey (DJ) audio commentary segments to one of a streaming Internet radio station host or a user device for real-time insertion into a music playlist.

### BACKGROUND OF THE INVENTION

In general, with increased geographic coverage and per device bandwidth capabilities of the emerging mobile internet technologies, traditional radio will now have many opportunities to exploit new business models and network architectures.

More specifically, there is a need for a service which allows a customized playlist for users on their mobile devices, but at the same time provides the near live DJ commentary which still gives the fresh feel of a traditional AM/FM terrestrial radio broadcast.

### SUMMARY OF THE INVENTION

The present invention generally relates to an Internet radio service which provides near live DJ style segments, also known as snippets, providing DJ commentary to host facilities of internet radio stations or directly to client devices such as a user's mobile device for late binding and, more particularly, to a method of and a system for implementing such an internet radio service.

According to one aspect, the present invention provides a method of providing near live disc jockey (DJ) audio commentary segments to a client device including one of an internet radio station host streaming device or a user device for real-time insertion into a music playlist, the method comprising: transmitting at least one metadata segment packet to the client device; transmitting at least one audio content segment packet to the client device, the at least one audio content segment packet matching directly to the at least one metadata segment packet; and receiving at least one usage segment packet as a response from the client device.

The present invention further provides a system for providing near live disc jockey (DJ) audio commentary segments to a client device including one of an internet radio station host streaming device or a user device for real-time insertion into a music playlist, comprising: means for transmitting at least one metadata segment packet to the client device; means for transmitting at least one audio content segment packet to the client device, the at least one audio content segment packet matching directly to the at least one metadata segment packet; and means for receiving at least one usage segment packet as a response from the client device.

The present invention further contemplates a computer readable medium comprising a program for instructing the system to perform the above-described operations.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS FIGURES

The accompanying drawing figures incorporated in and forming a part of this specification illustrate several aspects of the invention, and together with the description serve to explain the principles of the invention.

FIG. 1 illustrates a basic diagram of a just-in-time (JIT) near live DJ service according to an exemplary embodiment of the present invention;

FIG. 2 illustrates an exemplary format of a multicast network stream and a unicast network stream of the just-in-time near live DJ service according to an exemplary embodiment of the present invention;

FIG. 3 illustrates a block diagram of a DJ snippet service according to an exemplary embodiment of the present invention;

FIG. 4 illustrates a block diagram of a DJ snippet creation function according to an exemplary embodiment of the present invention;

FIG. 5 illustrates a block diagram showing integration of a client plug-in to a user device;

FIG. 6 illustrates a vendor branded Internet radio station used in conjunction with the just-in-time live DJ service according to an exemplary embodiment of the present invention; and

FIGS. 7A and 7B schematically illustrate the multicast embodiment in comparison to a further unicast embodiment.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

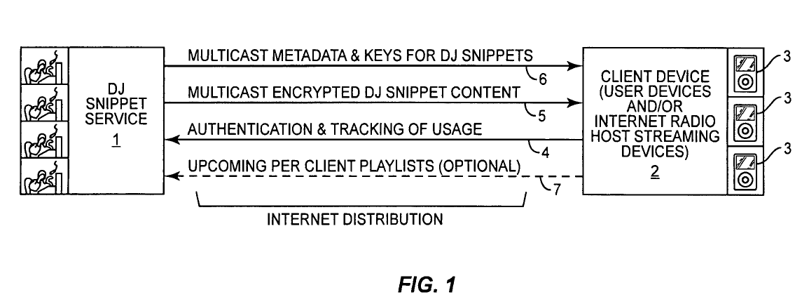

FIG. 1 illustrates a basic diagram of a just-in-time near live DJ service according to an exemplary embodiment of the present invention. More specifically, the internet radio DJ snippet service 1 provides near live DJ style commentary snippets or segments to a client device 2 which may include internet radio station host streaming devices and/or directly to user devices including portable media devices and smart phones, such as but not limited to iPods® or iPhones® 3, for late binding. The DJ snippet service 1 makes use of, for example but not limited to, IPv6 network capabilities to multicast a separate metadata feed with identifying tags just ahead of the snippet stream or streams. The centralized DJ snippet service 1 generates audio blips, such as DJ commentary relating to a particular song or advertisement, to be inserted with music at remote locations. Due to the live nature or near live nature of the audio blips, the snippets are tagged and immediately provided as a multicast over the Internet. The snippet transmission is buffered just enough to allow tagging and a separate multicast identifies metadata from the tagging to reach clients first for pre-identification.

As clients use one (or more) of the DJ snippets, an authentication is provided back to the service and allows closure of the business model. If the DJ snippets are advertisement based (or supplemented), the authentication provides a tracking means to bill the advertiser as shown at 4 in FIG. 1. Otherwise, the authentications may be tracked against clients for a subscription type service. To protect against unauthorized usage, the content is encrypted (digital rights management (DRM) locked) before transmission as at 5, and keys are provided on the metadata multicast to a plug-in or application on the client as at 6. This application is also responsible for sending the authentication when a snippet is decrypted. As an optional feature, playlists may be aggregated from multiple clients as at 7 to generate strategies for DJs and local to server feedback loops to see if DJ generated content is getting well matched to proposed playlists.

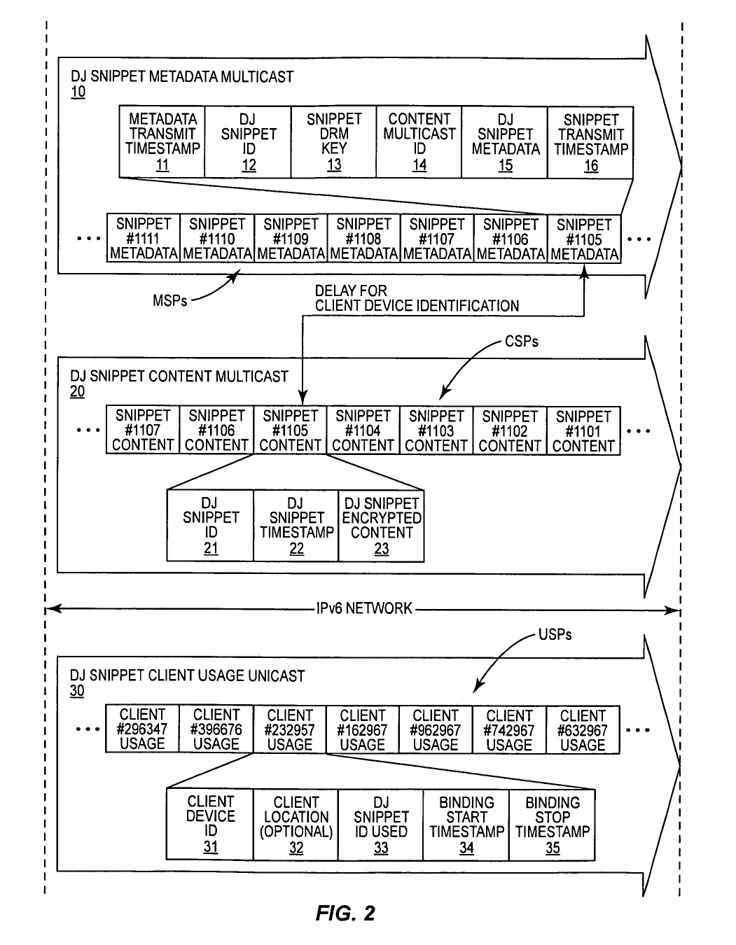

An exemplary format of the multicast and unicast network streams for this system are shown in FIG. 2. The DJ snippet metadata broadcast or multicast 10 contains a packet or group of packets referred as multicast metadata snippet or segment packets (MSPs) (for example, metadata snippet or segment packets MSPs #1105-#1111 are shown in FIG. 2) identifying each of the upcoming DJ snippet packet(s). For purposes of this description, a single packet MSP #1105 will be referenced and assumed to be encapsulated at Layer-4 or above of the network protocol stack (i.e., a packet described in this disclosure will most likely reference multiple snippet packets at the IPv6 Layer-3). Components of the metadata snippet or segment packet (e.g., #1105) include (but are not limited to) the following:

Metadata transmit timestamp 11 (transmit timestamp of the metadata packet);
DJ snippet identification (ID) 12;
Snippet DRM key 13;
Content multicast ID 14;
DJ snippet metadata 15; and
Snippet transmit timestamp 16 (transmit timestamp of the actual snippet packet).

The separate timestamps 16 provide a method to predict arrival of the snippet packet (i.e., by using the delta of the timestamps, network delays can be eliminated). The DJ snippet ID 12 is a unique identifier or serial number for tracking of multicast metadata snippet or segment packets (MSPs) to multicast audio content snippet or segment packets (CSPs). Use of a separate DJ snippet ID 12 (versus using the timestamp 16) allows for many metadata multicast feeds to co-exist on the same network. For example, one DJ snippet metadata multicast 10 may be for rock stations, while others are for jazz and country. The snippet DRM key 13 allows the client device 2 to decrypt the MSP. A unique key for each snippet allows selected authorization for clients (i.e., advertisement (ad) supplemented services would have access to certain snippets while subscription services would have access to additional snippets). Using the key also allows hacked clients to be turned off, and update real clients with new decryption algorithms. Finally, the metadata for the MSP may include, but would not be limited to, the following:
Genre, decades, tempo, artist, song, etc.
DJ identifier (bio, etc.)
Relevance (to music, news, weather, sports, traffic, comedy, etc.)
Snippet keywords (Bush, Hillary, Letterman, etc.)
Length of snippet (5, 10, 30, etc., seconds)

For instance, the DJ identifier may just include a uniform resource locator (URL) and subdirectory to a full description of the announcer. In a similar fashion, the music related metadata may also point to a URL and subdirectory detailing matching characteristics. For both of these, the client device 2 using the service would first go to the URLs to identify relevant DJ and music tags. One skilled in the art will recognized many methods and usage of metadata matching to content playlists.

The DJ multicast audio content snippet or segment packet (CSP) (e.g., #1105) comprises a DJ content snippet ID 21, a DJ content snippet transmit timestamp 22 and a DJ snippet encrypted content 23, which match directly to the metadata broadcast. The order of information within the snippet packets in both the DJ snippet metadata multicast 10 and the DJ snippet audio content multicast 20 may be arranged differently than shown in FIG. 2. Depending on transport (Layer-4) reliability, cyclic-redundancy-checks (CRCS) and or forward-error-correction (FEC) techniques may be applied directly to one or both multicast types.

The upstream return path from the client devices 2 shown in FIG. 2, is a DJ snippet client usage unicast 30 response from each client in the form of a unicast usage snippet or segment packet (USP). This response may be non-acknowledged (non-ACKed) User Datagram Protocol (UDP) or acknowledged (ACKed) Transmission Control Protocol (TCP) (reliable transport). If a non-ACKed approach is used, a routine check may need to be completed between the client and server to confirm that the client USPs are not being filtered (i.e., cheating the billing process). Information in these USPs (for example, Client #232957 Usage) may include a client device ID 31, a client location 32, and a DJ snippet ID used 33. Binding start timestamp 34 and binding stop timestamp 35 for start and stop times of binding for the client USP are also included. This allows for a pro-rated billing if the user changes internet radio channels while the USP is being played. Other useful information may also include client location (GPS, etc.).

Also, (although not shown in FIG. 2), the upstream client usage snippet packet USP may include additional real-time client information such as (but not limited to) the following:
Recent listening history
Upcoming playlist (if available)
Recent device location movements (delta GPS)
Device capabilities (available memory, listening volume, display availability, etc.)

This supplemental data can be used in conjunction with actual usage data for feedback to DJs to better target the listening audience. This may be of most benefit when the ratio of client devices to DJs is low.

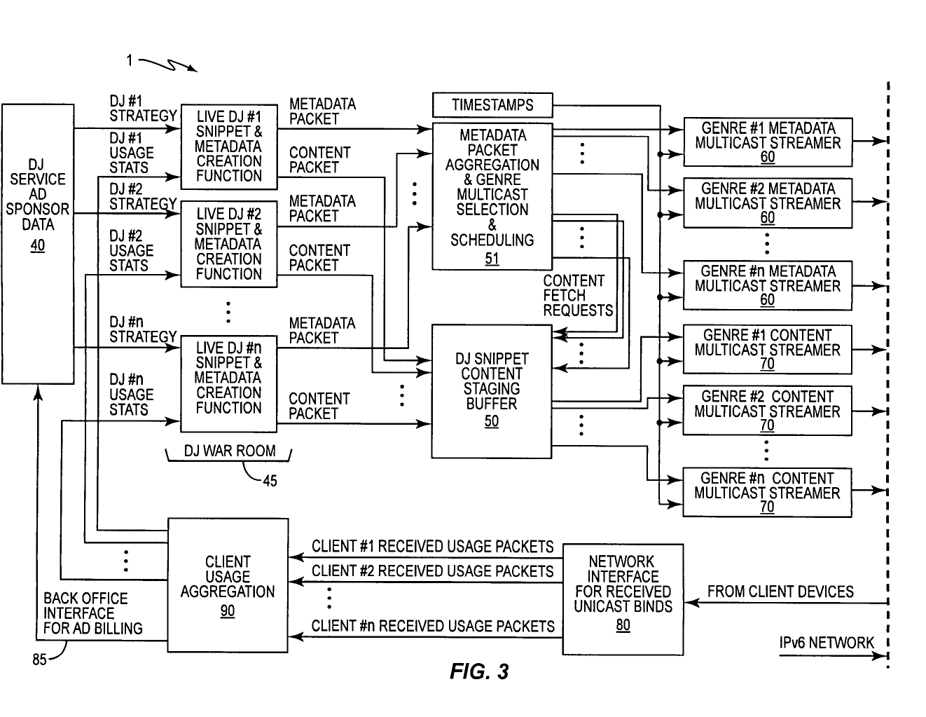

A block diagram showing a control system including components for operating the JIT near live DJ service 1 is illustrated in FIG. 3. Individual DJs (e.g., DJ #1, DJ #2, . . . DJ #n) with a live or automated tagging feature provide a snippet and metadata creation function. Multiple instances of the creation function comprise a type of DJ war room 45, where many simultaneous snippets can be created to support a large network of multiple clients and/or re-streamed internet radio stations.

Content from the creation function goes into a memory in the form of a DJ snippet content staging buffer 50 for short term storage until fetched to be multicast. Metadata is aggregated, sorted for a given multicast as at 51, and scheduled for transmission via timestamps 52. The scheduling function identifies multicast and transmission times to the audio snippet staging buffer 50. Finally, metadata snippet or segment packets (MSPs) are sent to the correct metadata multicast streamer 60, and content snippet or segment packets (CSPs) are sent to their respective content multicast streamer 70. Actual transmission timestamps 52 are applied as packets are sent. Returned client authentication packets in the form of client usage snippet or segment packets (USPs) are received via a unicast network interface 80. The packets are processed for billing purposes (such as ad sponsors) as shown in FIG. 3 by communication line 85 which communicates back with the DJ service ad sponsor data 40. These received usage packets are also aggregated at the client usage aggregation 90 on a per DJ basis for dynamic adjustments to snippet content information.

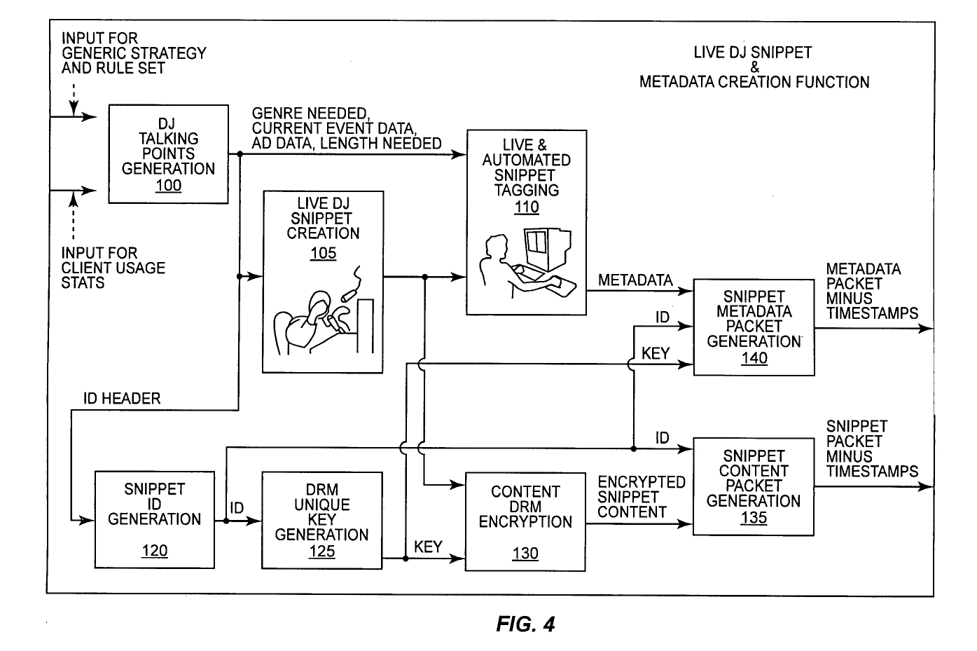

Further details of the snippet or segment creation function is shown in FIG. 4. A given DJ receives talking points or other information related to genre, current events, etc. as at 100. Included as input for such DJ talking points may be input for generic strategy and rule set and/or input for client usage statistics. Advertisement or sponsor data may also be provided (i.e., DJ would lead a snippet with “this segment is being brought to you by” Coke®) or Pepsi®). Target segment lengths are given to DJs as well. ID headers represent a given DJ and pre-tag the initial snippet. Each snippet generated as shown by the live DJ snippet creation function 105 goes to a more detailed tagging function that may be live, automated, or a combination of both as at 110 (i.e., keywords may be directly generated in a speech-to-text function, while more complex tagging is done by a music expert).

In parallel to the tagging functions, unique snippet IDs are generated as shown by a snippet ID generation function 120 and DRM encryption keys are generated for each snippet as shown by a DRM unique key generation function 125. As content is sent for tagging, content is also DRM encrypted to the key as shown by a content DRM encryption function 130. Finally, the snippet ID generated by the snippet ID generation function 120, key generated by the DRM unique key generation function 125, and encrypted content generated by the content DRM encryption function 130 are sent to the snippet content packet generation function 135 and output to the staging buffer 50 of FIG. 3. Likewise, metadata, IDs, and keys are sent to the snippet metadata packet generation function 140 and output to the aggregation device 51 of FIG. 3.

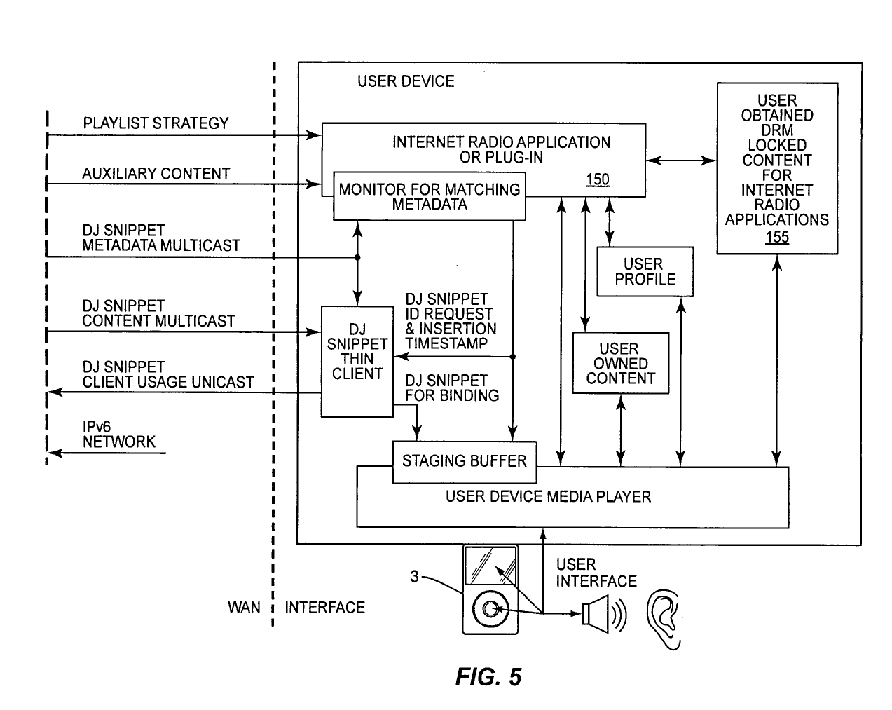

A block diagram showing integration of the client plug-in 150 to a user device 3 is shown in FIG. 5. The plug-in 150 receives selected metadata multicasts as may be requested by the playback application. For this example, a client generated model will be used. DRM locked music content 155 is provided to the application and specific metadata streams are monitored for matching DJ snippet availability. As snippets are identified, a request is made to the plug-in 150 with the snippet unique ID. The plug-in 150 also monitors the metadata multicast 10, retrieves the content multicast 20 address, joins the multicast, and obtains the DRM locked audio snippet. The plug-in 150 then uses the retrieved key to decrypt the snippet before providing to the application. The plug-in then returns the snippet ID and timestamp to the central server via a unicast (UDP or TCP) network transmission.

### EXAMPLE

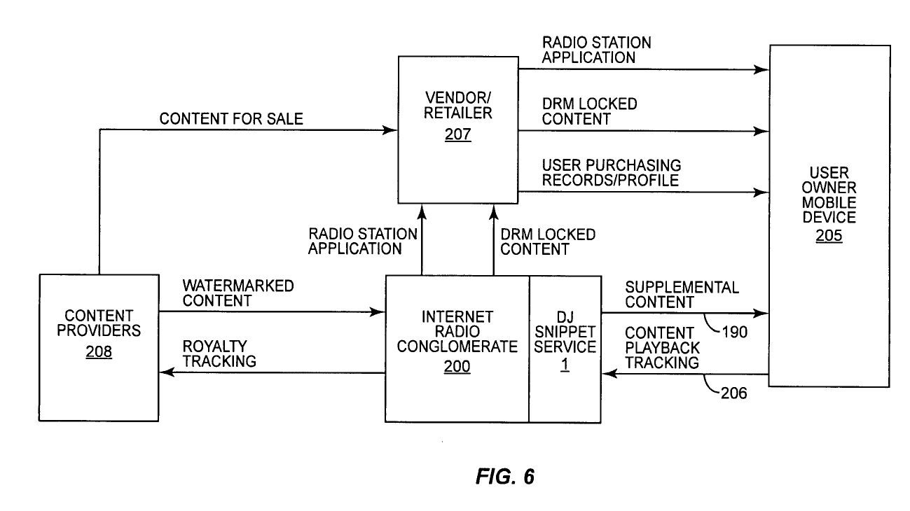

A simple example would be in support of a use case for vendor branded internet radio the ecosystem of which is shown in FIG. 6. The DJ service 1 (i.e., metadata data multicast 10 and content multicast 20) would operate under the supplemental content interface 190 between the internet radio station conglomerate 200 and the user mobile device 205. The usage unicast 30 upstream transmission would fall within the content playback tracking interface 206. Pure advertisement based content could co-exist with the DJ service 1 and be identified/transported within the same multicast infrastructure.

In the example, a vendor/retailer 207 partners with the large internet radio conglomerate 200 to provide a client (user owner mobile device 205) based radio station with the intent of providing direct and indirect advertising for the vendor/retailer 207. The large Internet radio conglomerate 200 provides access to content and royalties tracking for usage of the station via business relationships with a large content provider 208. The content maybe initially watermarked to identify that it is for radio station usage only and not for resale. The large internet radio conglomerate 200 would then DRM lock the content and provide the same to the vendor/retailer 207. The vendor/retailer 207 then provides distribution of the client and DRM locked content for access by only the user's mobile device 205.

The user then downloads/receives the radio station client for their mobile device 205 when visiting the vendors/retailer 207. Additionally, the user receives DRM locked content (such as music) as a reward for visiting the vendor/retailer 207 or based on purchases from the vendor/retailer 207. In addition to downloading the application and content, a user profile based on purchasing records may be obtained. Moreover, the user may activate the radio station through a common user interface and playback device that operates the vendor/retailer 207 radio station as a plug-in.

The present invention has substantial opportunity for variation without departing from the spirit or scope of the present invention. For example, as alternative embodiments, the centralized model may be distributed in any form most suitable to network topology and location of client or re-streaming internet radio host sites. Separation may also be imposed to better match national and local listening audiences.

Further, audio snippets may be watermarked prior to encryption to prevent unauthorized reuse if client devices become compromised. The watermark would contain snippet ID and copyright information for the service. Other protections may include separating DRM keys from the metadata multicast and have the client plug-in negotiate a common key or individual snippet keys from the centralized service.

Specialized ad or subscription models may also be provided, allowing garage shop internet radio stations to have a more polished and professional appearance. This may require additional back-office and hosting radio station interfaces.

Such a DJ service could be key offering of large radio station owners and potential local franchises allowing for leverage of internet radio functionality while still providing the fresh feel of AM/FM terrestrial radio. Business models include ad based or subscription services as discussed previously.

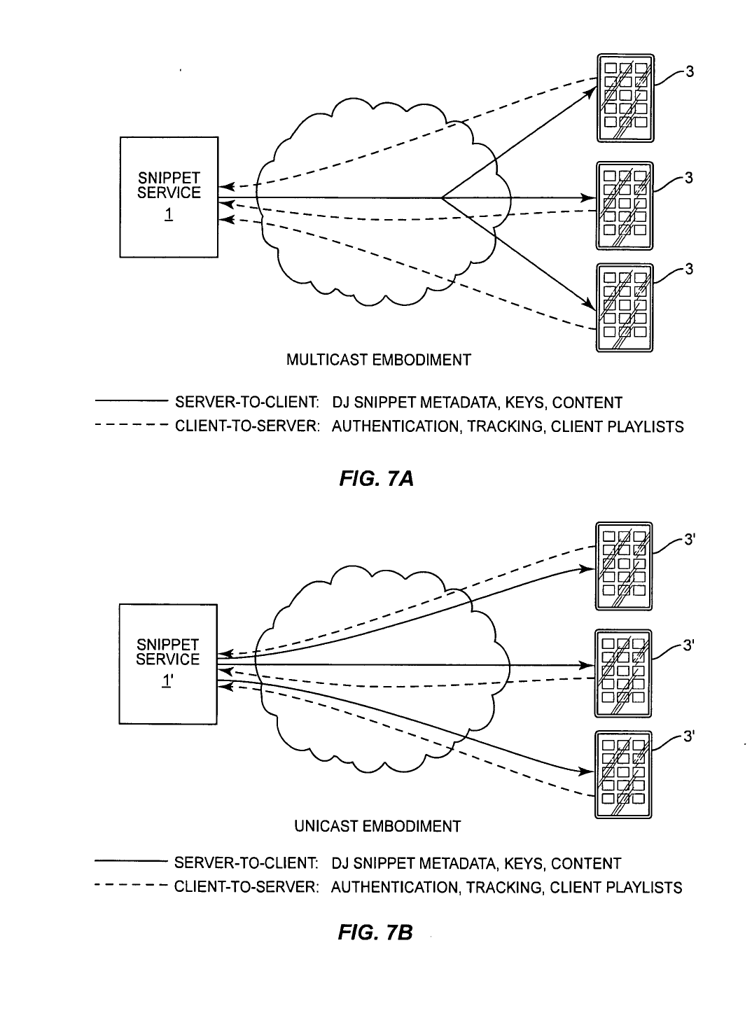

While a multicast embodiment has been described above as an exemplary embodiment, the present invention is not limited thereto. In this regard, as shown in FIG. 7A, the basic function of multicast technology is to efficiently distribute messages (or packets) from one source (e.g., snippet service 1) to multiple receivers such as user devices 3. The efficiency comes from the fact that each source has to transmit only a single packet addressed to a specific multicast group, and the intermediate network takes care of replicating each packet and propagating it to all intended receivers, which are basically subscribers to that multicast group.

However, as shown in FIG. 7B, it is possible to achieve multicast functionality without multicast support from the network, by simply having the source 1′ transmit multiple unicast packets, one to each intended receiver 3′. This lacks the efficiency of the multicast approach, as it requires the source 1′ to transmit the same packet separately for each receiver 3′, but has the advantage of not relying on the network to support this functionality. This is useful because currently multicast has very limited deployment in the Internet, and hence multicast's functionality is not yet widely available. Hence, instead of multicasting the Metadata, Encryption Keys, and Encrypted DJ Snippet Content to all receiving Client Devices 3′, the DJ Snippet service 1′0 can also send the same via multiple unicast transmissions, one to each receiving client device 3′. In the multicast embodiment, each Client Device 3 “joins” a specific multicast group by subscribing to its address in the network, and the Snippet Service 1 simply publishes to this multicast address. In the unicast embodiment of FIG. 7B, since there is no reliance on the network to provide this subscription facility, the following steps are performed:
1. The Snippet Service 1′ maintains a list of current subscribers and their IP addresses.
2. Each Client Device 3′ that wishes to receive the snippet information registers with the Snippet Service 1′ by directly sending the Snippet service 1′ a unicast packet and requesting to be included.
3. The Snippet Service 1′ adds the address of that Client Device 3′ to its list of subscribers.
4. For each packet that has to be published, the Snippet Service 1′ transmits the packet via unicast to each subscribing Client Device 3′.

In another embodiment, Peer-to-Peer (P2P) techniques are used to establish an “Application-Level Multicast” (ALM) distribution channel from the Snippet Service source to the receiving Client Device. In this case, the first steps are identical to steps 1-3 from the unicast embodiment above, but then at step 4, the Snippet Service transmits each packet via unicast to only a subset of the subscribing Client Devices. On receiving each packet, these Client Devices then propagate it via unicast to a subset of other Client Devices that may have not yet received the packet. This propagation continues recursively until every Client Device receives each packet. The Client Devices may communicate with each other in a distributed manner, and/or with a central server (the Snippet Service,) to organize themselves so as to achieve the most efficient distribution of packets. Thus, in the ideal case, none of the involved devices—neither the Snippet Service nor any of the Client Devices—have to transmit every packet to every other device, but only a small subset, greatly reducing the load on any single device. In this way, the Client Devices simulate multicast functionality at the Application layer rather than rely on it at the Network layer (in reference to the 7-layer OSI model). Thus, the present invention is not limited to the multicast embodiment and also contemplates a unicast embodiment or a peer-to-peer embodiment or a combination of all three.

Those skilled in the art will recognize improvements and modifications to the preferred embodiments of the present invention. All such improvements and modifications are considered within the scope of the concepts disclosed herein and the claims that follow.

What is claimed is:

1. A method of providing near live disc jockey (DJ) audio commentary segments to a client device including one of an internet radio station host streaming device or a user device for real-time insertion into a music playlist, the method comprising:
transmitting at least one metadata segment packet to the client device;
transmitting at least one audio content segment packet to the client device, the at least one audio content segment packet matching directly to the at least one metadata segment packet; and
receiving at least one usage segment packet as a response from the client device.

2. The method of claim 1, wherein the at least one metadata segment packet includes a DJ segment identification which serves as a unique identifier for tracking of the at least one metadata segment packet to the at least one audio content segment packet.

3. The method of claim 1, wherein the at least one metadata segment packet includes a segment digital rights management key for allowing the client device to decrypt the at least one metadata segment packet.

4. The method of claim 1, wherein the at least one metadata segment packet includes a content identification.

5. The method of claim 1, wherein the at least one metadata segment packet includes a DJ segment metadata.

6. The method of claim 1, wherein the at least one metadata segment packet includes a segment transmit timestamp for predicting arrival of the at least one metadata segment packet.

7. The method of claim 1, wherein the at least one audio content segment packet includes a DJ content segment identification.

8. The method of claim 1, wherein the at least one audio content segment packet includes a DJ segment encrypted content.

9. The method of claim 1, wherein the at least one audio content segment packet includes a DJ content segment transmit timestamp.

10. The method of claim 1, wherein the at least one usage segment packet includes a client device identification.

11. The method of claim 1, wherein the at least one usage segment packet includes a binding start timestamp and a binding stop timestamp.

12. The method of claim 1, further comprising tracking and processing the at least one usage segment packet to perform a billing function for billing at least one of an advertiser based on advertisement segments or a user based on a user subscription.

13. The method of claim 1, wherein the user device comprises a mobile device.

14. The method of claim 13, wherein the mobile device comprises one of a portable media device or a smart phone.

15. The method of claim 1, wherein at least one of the at least one metadata segment packet and the at least one audio content segment packet is transmitted to the client device via multicast transmission.

16. The method of claim 1, wherein at least one of the at least one metadata segment packet and the at least one audio content segment packet is transmitted to the client device using unicast propagation.

17. The method of claim 1, wherein at least one of the at least one metadata segment packet and the at least one audio content segment packet is transmitted to the client device via peer-to-peer techniques.

18. The method of claim 1, wherein at least one of the at least one metadata segment packet and the at least one audio content segment packet is transmitted to the client device via a combination of multicast, unicast and peer-to-peer transmissions.

19. A system for providing near live disc jockey (DJ) audio commentary segments to a client device including one of an internet radio station host streaming device or a user device for real-time insertion into a music playlist, comprising:
means for transmitting at least one metadata segment packet to the client device;
means for transmitting at least one audio content segment packet to the client device, the at least one audio content segment packet matching directly to the at least one metadata segment packet; and
means for receiving at least one usage segment packet as a response from the client device.

20. The system of claim 19, wherein the at least one metadata segment packet includes a DJ segment identification which serves as a unique identifier for tracking of the at least one metadata segment packet to the at least one audio content segment packet.

21. The system of claim 19, wherein the at least one metadata segment packet includes a segment digital rights management key for allowing the user device to decrypt the at least one metadata segment packet.

22. The system of claim 19, wherein the at least one metadata segment packet includes a content identification.

23. The system of claim 19, wherein the at least one metadata segment packet includes a DJ segment metadata.

24. The system of claim 19, wherein the at least one metadata segment packet includes a segment transmit timestamp for predicting arrival of the at least one metadata segment packet.

25. The system of claim 19, wherein the at least one audio content segment packet includes a DJ content segment identification.

26. The system of claim 19, wherein the at least one audio content segment packet includes a DJ segment encrypted content.

27. The system of claim 19, wherein the at least one audio content segment packet includes a DJ content segment transmit timestamp.

28. The system of claim 19, wherein the at least one usage segment packet includes a client device identification.

29. The system of claim 19, wherein the at least one usage segment packet includes a binding start timestamp and a binding stop timestamp.

30. The system of claim 19, wherein the user device comprises a mobile device.

31. The system of claim 30, wherein the mobile device comprises one of a portable media device or a smart phone.

32. The system of claim 19, further comprising means for tracking and processing the at least one usage segment packet to perform a billing function for billing at least one of an advertiser based on advertisement segments or a user based on a user subscription.

33. The system of claim 19, wherein at least one of the at least one metadata segment packet and the at least one audio content segment packet is transmitted to the client device via multicast transmission.

34. The system of claim 19, wherein at least one of the at least one metadata segment packet and the at least one audio content segment packet is transmitted to the client device using unicast propagation.

35. The system of claim 19, wherein at least one of the at least one metadata segment packet and the at least one audio content segment packet is transmitted to the client device via peer-to-peer techniques.

36. The system of claim 19, wherein at least one of the at least one metadata segment packet and the at least one audio content segment packet is transmitted to the client device via a combination of multicast, unicast and peer-to-peer transmissions.

37. A computer readable medium comprising a program for instructing a system, which provides near live disc jockey (DJ) audio commentary segments to a client device including one of an internet radio station host streaming device or a user device for real-time insertion into a music playlist, to:
transmit at least one metadata segment packet to the client device;
transmit at least one audio content segment packet to the client device, the at least one audio content segment packet matching directly to the at least one metadata segment packet; and
receive at least one usage segment packet as a response from the client device.

38. The computer readable medium of claim 37, wherein the at least one metadata segment packet includes a DJ segment identification which serves as a unique identifier for tracking of the at least one metadata segment packet to the at least one audio content segment packet.

39. The computer readable medium of claim 37, wherein the at least one metadata segment packet includes a segment digital rights management key for allowing the user device to decrypt the at least one metadata segment packet.

40. The computer readable medium of claim 37 wherein the at least one metadata segment packet includes a content identification.

41. The computer readable medium of claim 37, wherein the at least one metadata segment packet includes a DJ segment metadata.

42. The computer readable medium of claim 37, wherein the at least one metadata segment packet includes a segment transmit timestamp for predicting arrival of the at least one metadata segment packet.

43. The computer readable medium of claim 37, wherein the at least one audio content segment packet includes a DJ content segment identification.

44. The computer readable medium of claim 37, wherein the at least one audio content segment packet includes a DJ segment encrypted content.

45. The computer readable medium of claim 37, wherein the at least one audio content segment packet includes a DJ content segment transmit timestamp.

46. The computer readable medium of claim 37, wherein the at least one usage segment packet includes a client device identification.

47. The computer readable medium of claim 37, wherein the at least one usage segment packet includes a binding start timestamp and a binding stop timestamp.

48. The computer readable medium of claim 37, wherein the user device comprises a mobile device.

49. The computer readable medium of claim 48, wherein the mobile device comprises one of a portable media device or a smart phone.

50. The computer readable medium of claim 37, further instructing the system to track and process the at least one usage segment packet to perform a billing function for billing at least one of an advertiser based on advertisement segments or a user based on a user subscription.

51. The computer readable medium of claim 37, wherein at least one of the at least one metadata segment packet and the at least one audio content segment packet is transmitted to the client device via multicast transmission.

52. The computer readable medium of claim 37, wherein at least one of the at least one metadata segment packet and the at least one audio content segment packet is transmitted to the client device using unicast propagation.

53. The computer readable medium of claim 37, wherein at least one of the at least one metadata segment packet and the at least one audio content segment packet is transmitted to the client device via peer-to-peer techniques.

54. The computer readable medium of claim 37, wherein at least one of the at least one metadata segment packet and the at least one audio content segment packet is transmitted to the client device via a combination of multicast, unicast and peer-to-peer transmissions.
